(19) United States
(12) Patent Application Publication
(10) Pub. No.: US 2008/0011431 A1
(43) Pub. Date: Jan. 17, 2008

(54) Shade having overlapping slats

(76) Inventor: Ya Li Lin, Shalu Township (TW)

Correspondence Address: BRUCE H. TROXELL, SUITE 1404, 5205 LEESBURG PIKE, FALLS CHURCH, VA, 22041, US

(21) Appl. No.: 11/486,206

(22) Filed: Jul. 14, 2006

(51) Int. Cl. E06B 9/26

(52) U.S. Cl. 160/166.1

(57) ABSTRACT

A shade having overlapping slats to provide a three dimensional arrangement and facilitate fast assembly and installation includes a plurality of slats braced and confined by at least two ladder bands to form overlap in a upper and down manner. Each of the slats has at least two anchor notches on one edge to be wedged by a cord of the ladder bands to form anchoring of the slats. The shade thus formed can be fabricated, assembled and installed easier, and provide three dimensional aesthetic appeal and more added value.

### BACKGROUND OF THE INVENTION

1. Field of the Invention

The present invention relates to a shade having overlapping slats and particularly to a shade that has overlapping slats arranged in a three dimensional manner and can be fabricated, assembled and installed rapidly and provide three dimensional aesthetic appeal and more added value.

2. Description of the Prior Art

Window coverings generally can be categorized in blinds, curtains and shades. The blinds generally are formed in a plain style and do not have much aesthetic appeal, and need a greater effort during winding and retraction, thus are mostly used in offices. The curtains and shades are more elegant and attractive, thus are widely used in houses. As the curtains also require a greater effort during winding and retraction, the shades become increasingly popular. Refer to FIG. 1 for a typical shade structure. It includes fabric panels 11, 12 and 13 that are movable transversely through drawing bars 111, 112 and 113 to block light and decorate the environment. These days the demand of indoor decoration becomes more diversified, the shade made merely from fabrics does not have three dimensional feeling, and material selection is limited to weaving and printing. In addition, in recent years health and green concept gain growing awareness, and building with natural means is trendy. The conventional technique of making shades from fabrics no longer meets user's requirements. Bamboo and wood become materials of choice. Making shades from bamboo and wood is a new trend. However, due to material nature, they are mostly fabricated by weaving. Refer to FIG. 2 for a conventional shade structure. It includes a plurality of threading cords 211 linking a plurality of transverse slats 21 through weaving machines to form a shade 2. Threading the cords is tedious and time-consuming. The surface of the shade 2 is plane without layer structure and does not have three dimensional visual effect. It does not have much appeal.

### SUMMARY OF THE INVENTION

In view of the aforesaid problems occurred to the conventional shade, the present invention aims to provide a shade with overlapping slats that is easier to fabricate, assemble and install. It also provides three dimensional effect with enhanced aesthetic appeal. The invention includes a plurality of slats braced and confined by at least two ladder bands. The slats are overlapped in a up and down manner to form the shade. Each slat has at least two anchor notches on one edge (upper edge or lower edge) to be wedged by a cord of the ladder bands for anchoring. Fabrication, assembly and installation are easier. The shade thus formed has three dimensional aesthetic appeal and provides more added value.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional shade.

FIG. 2 is a plane view of a conventional shade.

FIG. 3 is a perspective view of the invention.

FIG. 4 is a fragmentary perspective view of the invention.

FIG. 5 is a fragmentary sectional view of the invention.

FIG. 6 is a plane view of a ladder band of the invention.

FIG. 7 is a fragmentary perspective view of another embodiment of the invention.

FIG. 8 is a fragmentary sectional view of another embodiment of the invention.

FIG. 9 is a fragmentary perspective view of another embodiment of the slat of the invention.

FIG. 10 is a fragmentary perspective view of yet another embodiment of the slat of the invention.

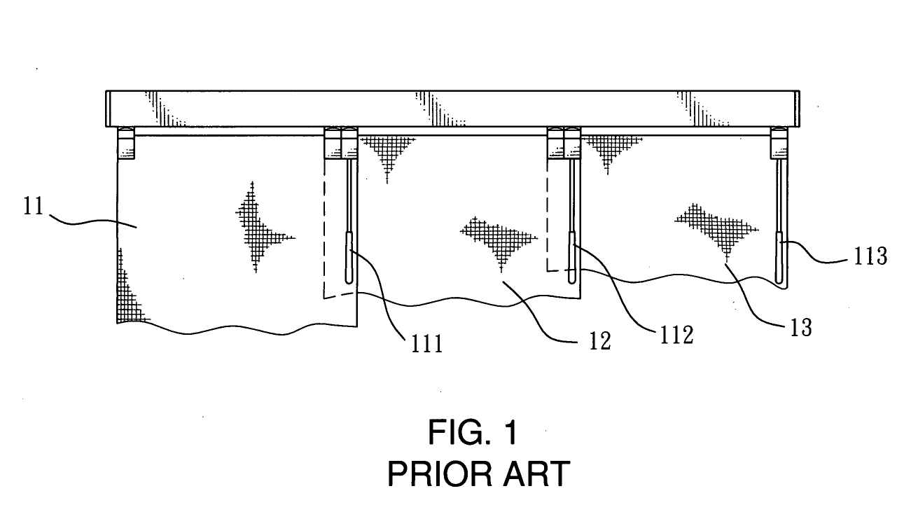

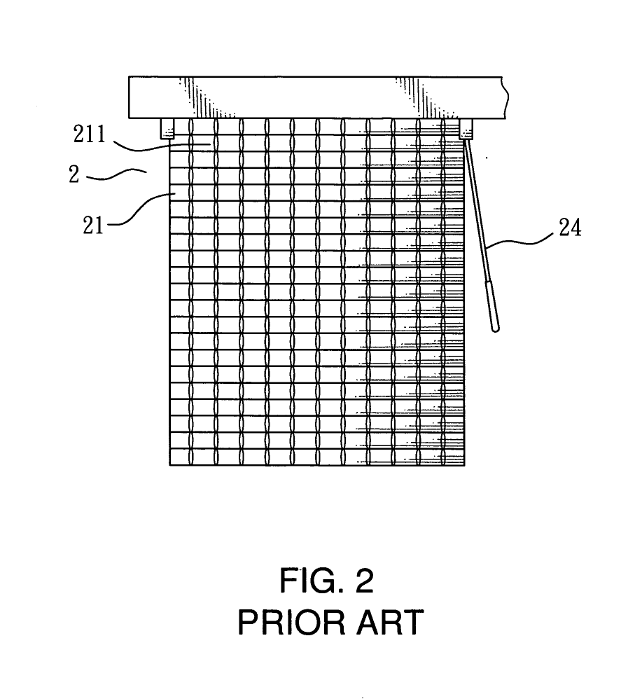

### DESCRIPTION OF THE PREFERRED EMBODIMENTS

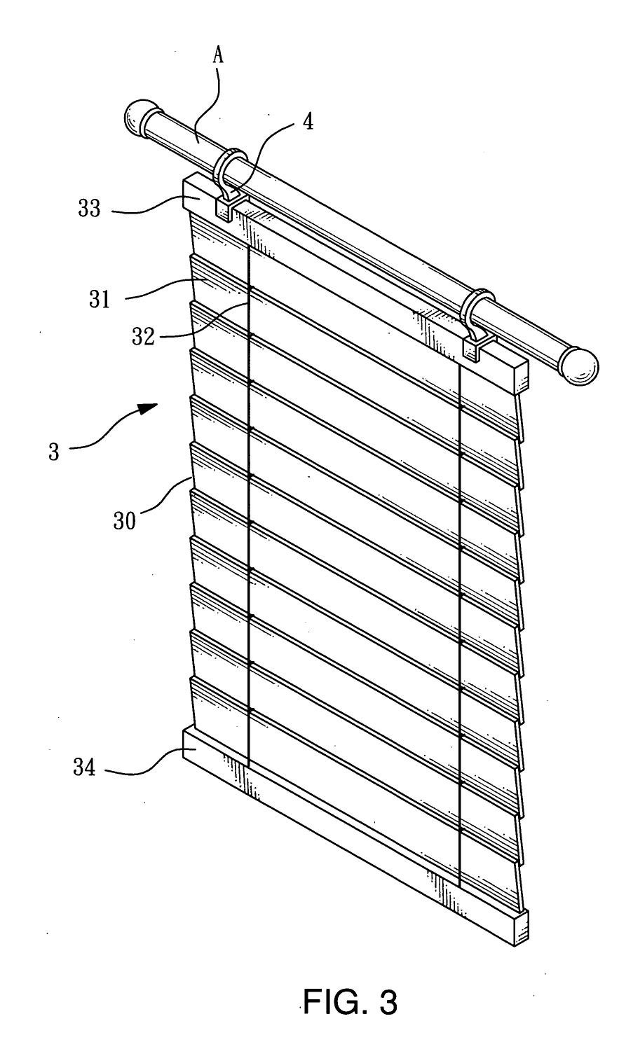

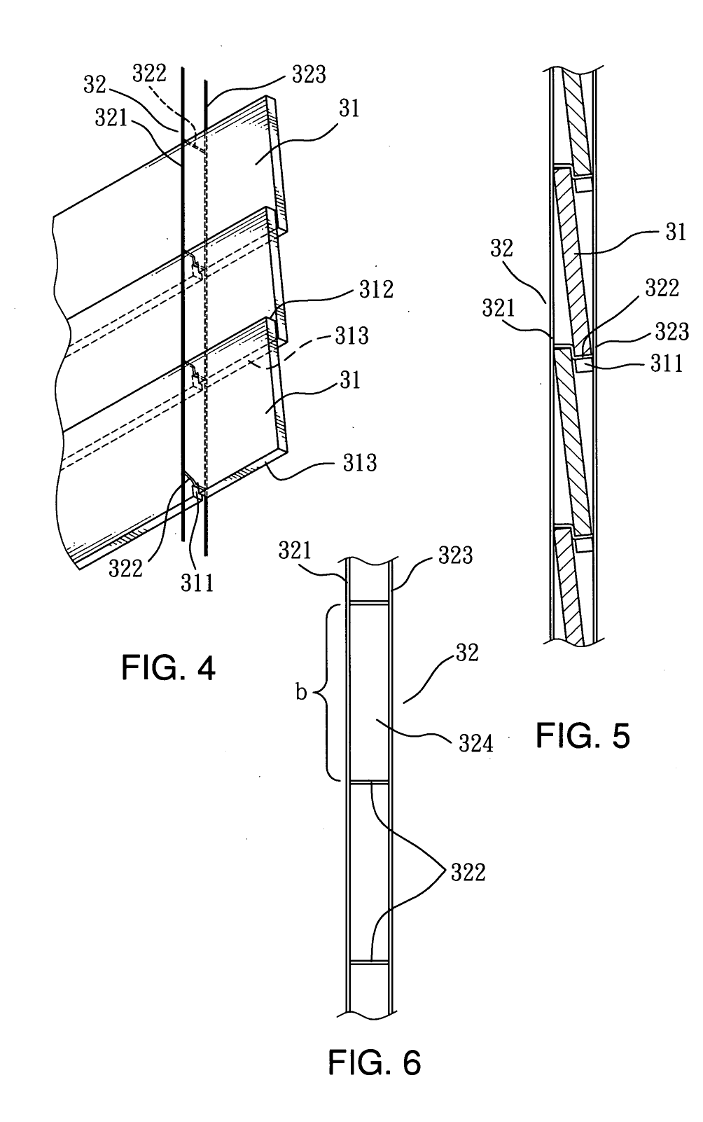

Referring to FIGS. 3, 4 and 5, the shade 3 according to the invention includes a plurality of slats 31, at least two ladder bands 32, a upper beam 33 and a lower beam 34. The upper beam 33 is fastened to one or more coupling element 4 (may be a hanging hook, a pulley or the like) to allow the shade 3 to be slid transversely to the left side and right side of a rod A (or a track). The ladder bands 32 link the upper beam 33 and lower bream 34 longitudinally such that the slats 31 are overlapped to from a shade body 30.

Each of the slats 31 has a lower edge 313 which has at least two anchor notches 311 formed thereon. Each of the anchor notches 311 is wedged by a cord of the ladder bands 32 to anchor the slat 31.

The ladder bands 32 have a first side cord 321 and a second side cord 323 that are parallel with each other, and band bridges 322 equally spaced from one another. Each of the band bridges 322 has two ends fastened to the first side cord 321 and second side cord 323 so that the ladder bands 32 divide the ladder bands 32 into a plurality of confining space segments 324. To prevent the slats 31 from flipping and moving after installation, the longitudinal side length b of each confining space segment 324 is preferably greater than the length of the band bridge 322 (referring to FIG. 6).

By means of the construction set forth above, one slat 31 is held and confined in one confining space segment 324 of the ladder bands 32. The anchor notch 311 on the lower edge 313 of each slat 3 is overlapped and masked by a upper edge 312 of a lower slat 3. Thus assembly and installation are easier and quicker. The shade thus formed also has three dimensional visual effect and is more appealing.

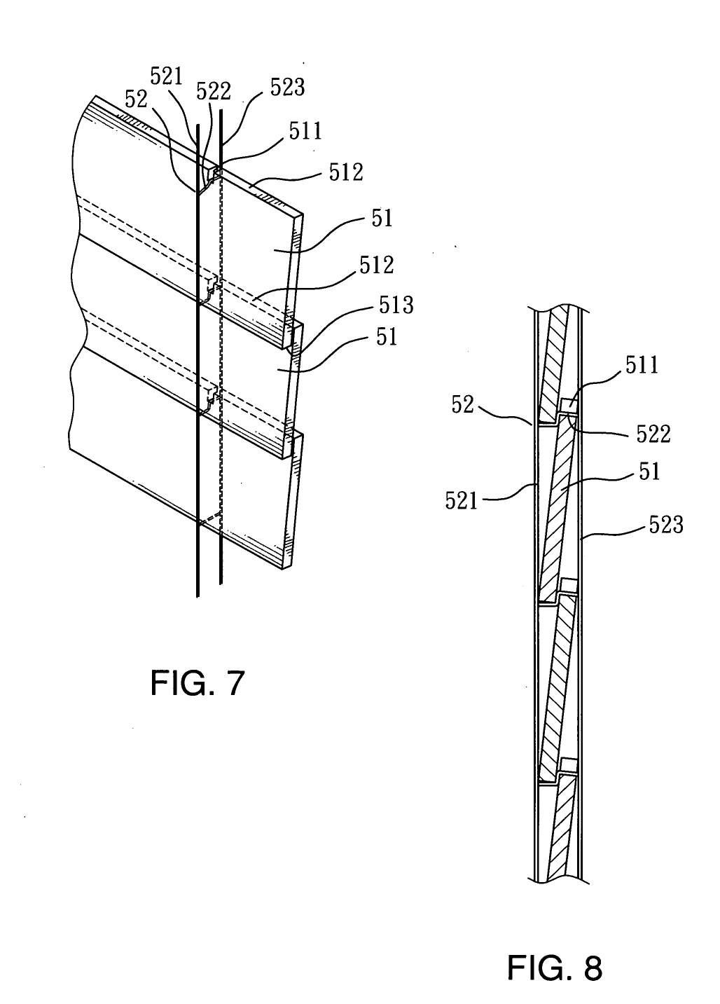

Refer to FIGS. 7 and 8 for another embodiment of the invention. In this embodiment a slat 51 has an anchor notch 511 formed on a upper edge 512. During assembly a lower edge 513 of a upper slat 51 overlaps and masks the anchor notch 511 and the upper edge 512 of the lower slat 51. There are also ladder bands 52 which have a first side cord 521 and a second side cord 523 bridged by band bridges 522 to form confining space segments 524 to hold and anchor the slat 51. Such a structure also makes assembly and installation easier and quicker. The shade thus formed also has three dimensional visual effect and is more appealing.

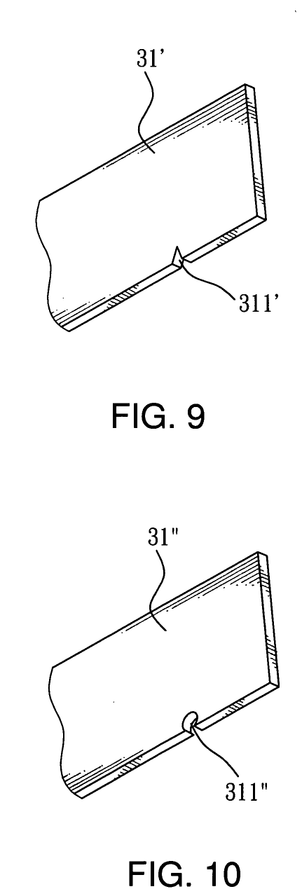

The anchor notch on the slat may be formed in any shape desired. FIG. 9 shows an embodiment with the anchor notch 311′ on the slat 31′ formed in a triangular shape. FIG. 10 illustrates another embodiment with the anchor notch 311″ on the slat 31″ formed in a circular shape. They all can facilitate wedging of the ladder band cord of varying styles.

In short, the invention provides a shade structure that can be fabricated and assembled quickly, and also provides three dimensional aesthetic appeal, and offers enhanced added value.

I claim:

1. A shade having overlapping slats comprising a upper beam, a lower beam, at least two longitudinal ladder bands linking the upper beam and the lower beam, and a plurality of slats held by the ladder bands in an overlapping manner; the upper beam being fastened to at least one coupling element to be coupled on a rod or a track to allow the shade to be slid transversely to a left side and a right side; wherein:
the ladder bands have a first side cord and a second side cord that are parallel with each other and bridged by band bridges which are equally spaced from one another to form a plurality of confining space segments to hold and confine the slats; and
each of the slats has at least two anchor notches formed on one edge to be wedged by the side cords to anchor the slats.

2. The shade having overlapping slats of claim 1, wherein the anchor notches are formed on a upper side of the slats.

3. The shade having overlapping slats of claim 1, wherein the anchor notches are formed on a lower side of the slats.

4. The shade having overlapping slats of claim 1, wherein the anchor notches are formed on a triangular shape.

5. The shade having overlapping slats of claim 1, wherein the anchor notches are formed on a circular shape.

6. The shade having overlapping slats of claim 1, wherein each of the confining space segments has a longitudinal length greater than the length of the band bridge.
